(19) United States
(12) Patent Application Publication
(10) Pub. No.: US 2006/0237482 A1
(43) Pub. Date: Oct. 26, 2006

(54) Device for dispensing a material in powder form, in particular freeze-dried drinks

(75) Inventor: Alain Vandebos, Meise (BE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: FOUNTAIN SA

(21) Appl. No.: 11/406,287

(22) Filed: Apr. 19, 2006

(30) Foreign Application Priority Data
Apr. 20, 2005 (EP) 05103178.9

(51) Int. Cl. B67D 5/06

(52) U.S. Cl. 222/181.3

(57) ABSTRACT

The invention relates to a base unit for a device for dispensing particulate material, in particular freeze-dried drinks, which comprises a first element which is designed to receive the pedestal of a receptacle supplying particulate material and which is provided with an opening drawer designed for the release of a quantity of particulate material coming from the said receptacle when it is in the open position.

The present invention relates to a base unit for a device for dispensing particulate material, in particular freeze-dried drinks, comprising:

A FIRST element that comprises at least one first substantially horizontal base plate and first and second lateral walls substantially perpendicular to the said first base plate, and

a first fixing means,

the said first element is designed to receive a pedestal on the said first base plate, a pedestal which is designed to house a receptacle for supplying particulate material and which is provided with an opening drawer, the said opening drawer comprising an open position and a closed position and in addition a second fixing means reciprocal with the said first fixing means, the said drawer being designed for the release of a quantity of particulate material coming from the receptacle when it is in the open position.

The present invention also relates to a device for dispensing particulate material, in particular freeze-dried drink, comprising the above mentioned base unit.

Such a base unit and such a dispensing device are known for example from the document U.S. Pat. No. 3,393,838, which describes a dispensing device comprising a base unit in which a supply receptacle is housed, provided with its pedestal with a drawer. The drawer of the said pedestal also has an open position and a closed position.

The base unit of the patent U.S. Pat. No. 3,393,838 also comprises a sliding drawer which comprises a fixing means for fixing the drawer of the base of the cartridge. Consequently, when the user pulls on the drawer of the base unit, he also opens the drawer of the cartridge since the drawer of a cartridge and the drawer of the base unit are fixed together. In the document U.S. Pat. No. 3,393,838, it is the drawer that is movable and the cartridge of product remains immobile in the base unit.

Unfortunately, this base unit is not very convenient in use and has the drawback that the particulate product agglomerates in the supply receptacle. This is because, first of all, a traction movement is never a natural movement easy for a user and then the particulate product, which is in general designed to be rapidly dissolved in water, agglomerates in contact with the stagnant atmosphere prevailing in the receptacle and under the effect of its own weight.

The aim of the invention is to mitigate the drawbacks of the prior art by procuring a base unit that is more simple to use, in which the user will serve himself with particulate material by a more natural and much easier movement, whilst resolving the problem of the agglomeration of the particulate material.

In order to resolve this problem, there is provided according to the invention a base unit as indicated at the beginning, in which the first fixing means is situated at the front of the first base plate.

This is because, when the first fixing means is situated directly on the said base plate, the drawer is fixed to the first element and always remains at the same place, whether this be in the closed position or in the open position. It is the supply receptacle that retracts with respect to the drawer through the pressure exerted by the user who wishes to serve himself with particulate material.

The first fixing means can also be situated on a front wall extending at the front of the base unit, substantially vertically with respect to the said base plate. The effect obtained will be exactly the same.

The first fixing means and the second fixing means can for example be chosen from amongst the fixing means consisting of at least one orifice and at least one protuberance designed to be housed in the orifice, or at least one recess and protuberance designed to be housed in the recess.

As already mentioned above, the drawer reaches its open position when the user pushes on the supply receptacle (cartridge of particulate material). Given that the drawer is fixed to the base unit, it is the retraction movement of the supply receptacle imposed by the user that will control the opening of the drawer. It is clear that pushing on the supply receptacle is a more simple and natural action, even more ergonomic for the user. The fact that the drawer always remains at the same place also enables the user to better aim at what point the particulate material will be dispensed and to better adjust the receptacle that he will place for example below the opening in order to recover this material. In the case of a dispenser of freeze-dried drink, the user will better be able to adjust his cup or glass, the result of which will be a cleaner use of the device. In addition, the retraction movement of the cartridge allows agitation of the particulate material and greatly limits its aggregation. The atmosphere prevailing is no longer a stagnant atmosphere and the product undergoing agitation at each use also no longer agglomerates under the effect of its own weight.

In a particularly advantageous embodiment, the base unit also comprises a second element, the said second element being designed to be housed in the first element and to house therein the receptacle for supplying particulate material with its base, the said second element comprising at least:

a second substantially horizontal base plate

a second rear wall,

third and fourth lateral walls, substantially perpendicular to the said second base plate,

the said first element and the said second element being designed to be able to move with respect to each other.

Second rear wall means either a relatively flat surface or a cylinder of the rod type or any similar means, connecting the third and fourth lateral walls. A substantially flat surface will be preferred as the rear wall, this may be of any size. This is because a flat wall amongst other things allows better holding in place of the lateral walls and the cartridge.

When a thrust is exerted by the user, the supply receptacle, encircled in this way by the second element, is not unbalanced, the weight of the receptacle is slightly increased by the presence of the second element which fulfils the role of a sheath, which improves its stability during the movement imposed. During the above-mentioned thrust, it is the second element that undergoes the retraction movement. As it encircles the supply receptacle and its pedestal, it imposes the retraction movement on the supply receptacle, whilst the drawer is secured to the first element which is fixed to it.

In one embodiment, the first element comprises at least one first translation means and the said second element comprises at least one second translation means, reciprocal with the above-mentioned first translation means.

As translation means, a channel (the first translation means) for guiding the second base plate to the second element can be cited, or guide rails (the first translation element) for guiding protuberances (the second translation means) situated either on the lateral walls or on the base plate of the second element or the opposite or any similar alternative for guiding the translation of the second element within the first element.

Through the presence of the guidance means for translation, the movement is more reproducible, which reduces the wear on the base unit and which simplifies further the use of the base unit. This is because, with a guided movement, the thrust exerted by the user is reduced and use is simplified.

In a variant, the first element comprises at least one first pivot means and the said second element comprises at least one second pivot means, reciprocal with the above-mentioned first pivot means.

In this particularly advantageous variant, the movement imposed by the user is a rotation movement, the effect of which is to provide better agitation of the product in the cartridge and limits further its aggregation. In addition the movement is even more propitious to the entry of the product into the opening of the drawer and the return rotation movement which returns the receptacle and drawer into the closed position has a scraper effect which reduces the jamming of the product between the pedestal and the drawer.

Pivot means mean for example a protuberance and an orifice, the orifice being able to be situated either on one or both lateral walls of the first element, or on one or both of the lateral walls of the second element, the protuberances consequently being situated respectively either on one or on both of the lateral walls of the second element or on one or both lateral walls of the first element. Naturally any similar pivot means can also be used, it is possible for example to envisage a curved groove which would guide a protuberance in a rotation movement, or even a groove comprising a first inclined or horizontal rectilinear portion and a stop arranged so as to guide any protuberance, the result of which would be a translation movement, inclined or not, retraction and then a rotation movement when the protuberance comes into contact with the stop.

Advantageously, the rear wall comprises guidance means arranged to guide flanges provided on lateral edges of the pedestal of the supply receptacle.

The presence of guidance means, for example a groove or a guide rail, arranged to receive the flanges of the said pedestal, enables the cartridge to be introduced into the second element more easily. The guidance makes the introduction movement of the cartridge provided with its pedestal more precise.

In a variant, to be compared for example with the above-mentioned variant, the first element comprises a first rear wall which comprises a first bottom part and a second top part which is curved and the second rear wall comprises a third bottom part and a fourth top part which is curved, the fourth top part having a curvature similar to that of the second curved part of the first element.

The curvature of the rear wall allows an even easier introduction of the cartridge. The movement of introduction of the cartridge by the user is as follows. The user has the cartridge in his hand in an inclined manner, he positions it against the rear face of the second element and slides it against the rear wall until it encounters the substantially vertical part, at this moment naturally he straightens up the cartridge and it exactly enters the cavity intended to house it, with the position that it should have.

If the embodiment comprising guide means for flanges situated at the pedestal is involved, introducing the cartridge will be even easier.

In another variant, it will be possible to envisage that the first and second rear walls be inclined instead of curved.

Preferably, the second rear wall of the second element comprises at least one row of openings, each opening being designed to receive a chock.

The chock limits the movement of the second element within the first element and consequently the result of this is limiting the mutual openings of the drawer/cartridge in order to limit the quantity of particulate product which is dispensed during the rotation movement.

Obviously it must be envisaged that the row of openings could be situated on the first rear wall or on the first base plate according to the embodiments adopted (translation or rotation movement).

The chock may have a U, L or I shape or a crescent moon or any similar shape, preferably the chock has an L shape. The L shape makes it possible to place two rows of openings staggered without a second end of the chock preventing the introduction of the first end of the chock in the orifice. In addition the L limits the entry of the chock into the orifice and affords a better grip for the user.

In a particularly preferential embodiment of the base unit according to the invention, means of fixing to a support are provided.

Other embodiments of the base unit according to the invention are indicated in the accompanying claims.

Another object of the invention is a device for dispensing particulate material, in particular freeze-dried drink, comprising the above-mentioned base unit.

Other embodiments of the device according to the invention are indicated in the accompanying claims.

Other characteristics, details and advantages of the invention will emerge from the description given below, non-limitingly and making reference to the accompanying drawings.

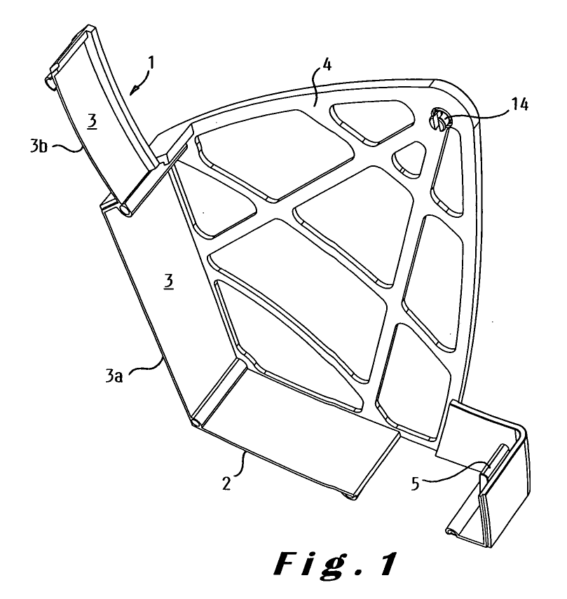

FIG. 1 is a lateral view in section of the first element of the base unit according to the invention.

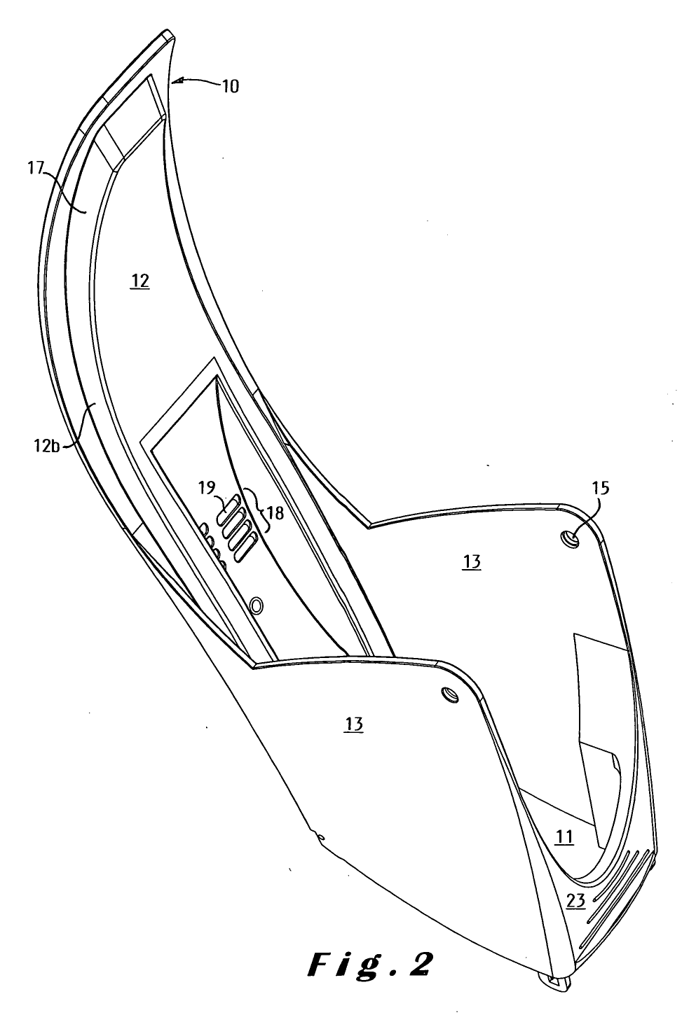

FIG. 2 is a view in perspective illustrating the second element according to the invention in which the row of orifices for locking the relevant movement of the two internal and external elements with respect to each other can be seen.

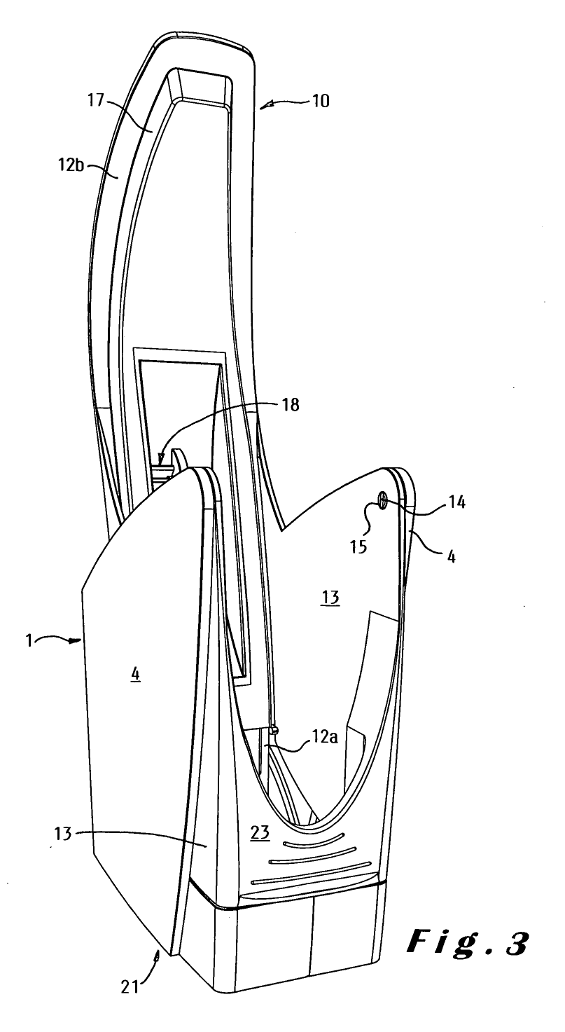

FIG. 3 is a view in perspective of the base unit comprising the first element and the second element in the particular embodiment where the relative movement of the two internal and external elements with respect to each other is a rotation movement.

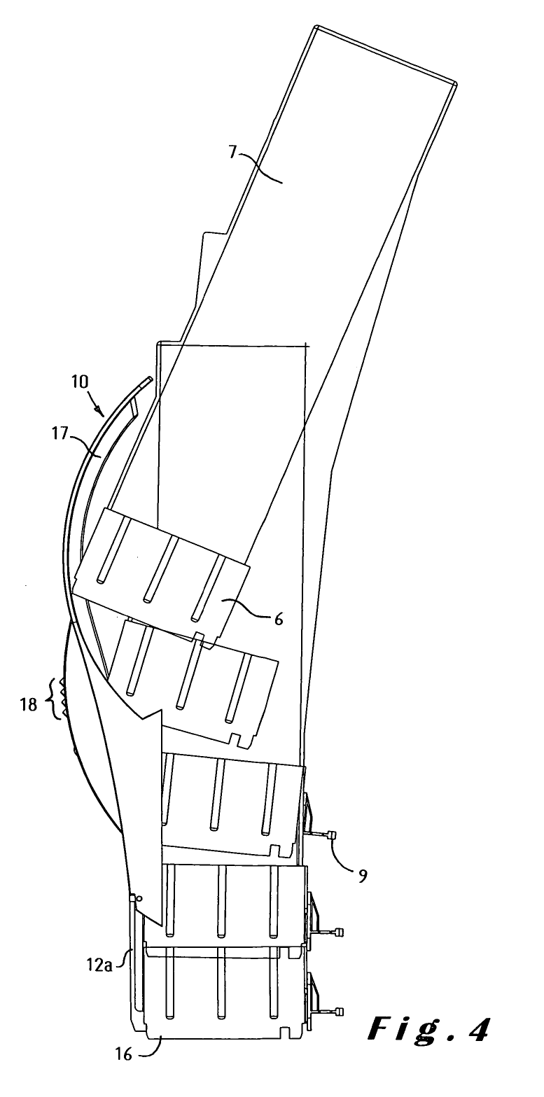

FIG. 4 is a schematic view illustrating the introduction of the supply receptacle into the second element of the base unit according to the invention.

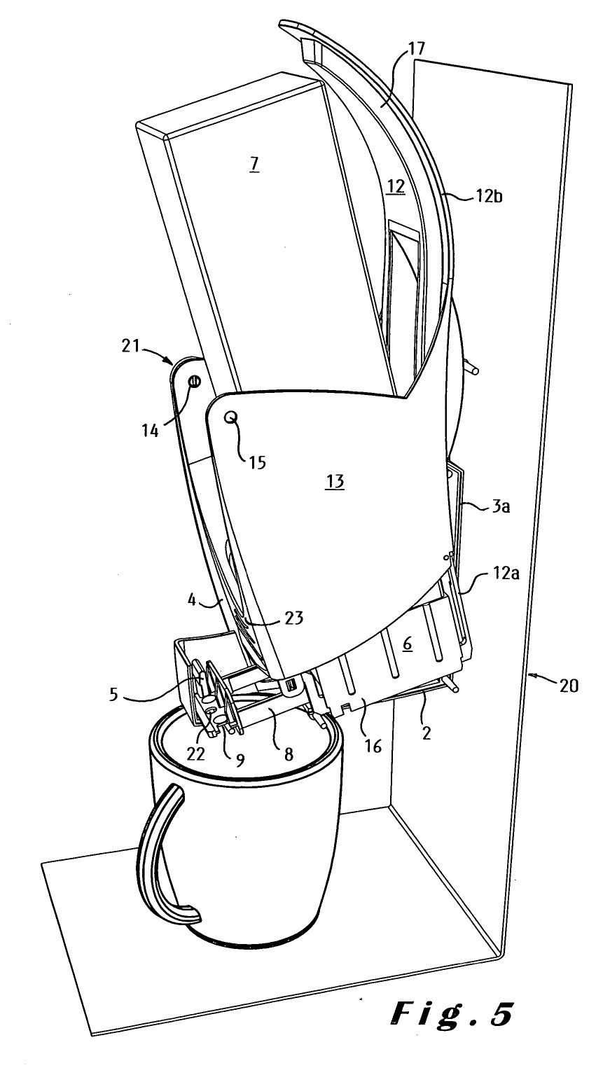

FIG. 5 is a view in perspective illustrating the particulate material dispensing device according to the invention, in its particular application as a device for dispensing freeze-dried drink.

In the figures, the identical or similar elements bear the same references.

As can be seen in FIG. 1, which depicts a view in perspective of half of the first element 1, the first element 1 comprises a first base plate 2.

The first element 1 also comprises a first rear wall 3 which extends substantially vertically. The first rear wall 3 comprises a first bottom part 3a and a second top part 3b, the first bottom part at least is perpendicular to the first base plate 2. In addition, the first element 1 comprises first and second lateral walls 4. These lateral walls 4 are both substantially perpendicular to the first bottom part 3a and the first base plate 2. In front of the first base plate 2 there is a first fixing means 5.

The first base plate is positioned relatively horizontally so that it is possible to rest a receptacle 7 for supplying particulate material on it (see also FIGS. 4 and 5).

The first base plate 2 serves in reality as an abutment and support surface for the above mentioned receptacle 7, possibly provided with its pedestal 6, which will also sometimes be referred to as the cartridge 7 provided with its pedestal 6.

The first element 1 also comprises at least one first pivot means 14, which may be an orifice in which a protuberance will come to be housed or a protuberance designed to be housed in an orifice. In the embodiment illustrated, the external element comprises a pivot means which is a protuberance 14, this protuberance 14 is situated on the internal top part of each lateral face 4, but it could be envisaged that this protuberance 14 or possibly the orifice would be situated anywhere on the first element 1, or even on a single lateral wall 4.

In FIG. 2, an illustration of the second element 10 can be seen. This second element 10 is designed to be placed in the first element 1. It comprises at least one second base plate 11. The second base plate 11 is substantially horizontal. It is designed to support any cartridge of particulate material 7 provided with its pedestal 6 and has a surface area slightly greater than the surface area of the base of the pedestal 6.

The second element 10 also comprises a second rear wall 12 which extends substantially vertically. The second wall 12 comprises a third bottom part 12a and a fourth top part 12b. The third bottom part 12a is at least substantially perpendicular to the second base plate 11.

The second element 10 also comprises a third and fourth lateral wall 13. These two lateral walls 13 are substantially perpendicular both to the third bottom part 12a and to the second base plate 11.

In addition, the second element comprises, in the embodiment, a pivot means 15 which is reciprocal with the first pivot means 14. The pivot means 15, in the preferential embodiment illustrated, is an orifice 15 designed to accept the protuberance 14. As mentioned above, it goes without saying that the pivot means 14 could be an orifice and that the pivot means 15 could be a protuberance, that these reciprocal pivot means can be situated anywhere on the first element and on the second element and that they can one or two in number.

In addition, in FIG. 2, it can be seen that the second rear wall comprises, in this embodiment, two rows of openings 18 which each comprise orifices 19 which are designed to receive a chock and a guidance means 17. The guidance means 17 is advantageously a rail in relief, but a person skilled in the art will envisage alternatives without any effort such as for example a pair of grooves, hollow channels, rails in relief, a single groove or channel or any other similar guidance means.

FIG. 3 illustrates the base unit 12 according to the invention in the mounted state. The second element 10 is housed in the external element 1. As can be seen, this embodiment is the embodiment in which the second top part 3b and the fourth top part 12b are curved parts which each have similar curvatures to each other to make it possible for the second element 10 to be housed in the first element 1. Advantageously, the second element also comprises a front face 23 possibly equipped with rebating.

FIG. 4 illustrates in profile the steps of introducing the supply receptacle 7 provided with its pedestal 6 into the second element 10 of the base unit 21 according to the invention. In order to simplify understanding, the first element has been removed from the representation.

In this particular embodiment, as shown in FIG. 3, the second rear wall 12 comprises guidance means 17. The pedestal 6 of the cartridge 7 comprises at least two lateral edges which each comprise flanges 16. Flanges means for example lateral extensions which extend lower than the bottom of the pedestal 6 and which in this way define projections on each side of the bottom of the pedestal 6. In this embodiment, the flanges 16 are designed to slide on each side of the rail 17 in relief on the second rear wall 12. A variant would consist of replacing the flanges with grooves. In this case, the rails 17 in relief would be replaced by flutes in relief which would engage in the aforementioned grooves. It could also be envisaged that the projections would be longer and that they would be designed to each engage in a rail situated on the second rear wall of the second element. In reality, many engagement devices (guidance element, guidance means) can be applied to replace the rail 17 in relief and the flanges 16, it is clear that all these engagement devices are included within the scope of the invention.

As illustrated in FIG. 4, the user only has to place the cartridge 7 provided with its pedestal 6 close to the top of the rail 17 in relief. He then adjusts the flanges 16 on each side of the relevant rail 17 in relief and the cartridge 7 of particulate matter is guided downwards by virtue of the particular shape of the rail 17 and rear walls 3, 12, gravity and the action of the user. The action of the latter is in fact a fluid action that is entirely natural, it suffices to support the cartridge 7 and, during its descent, to lift it slightly vertically.

FIG. 5 illustrates the base unit 10 fixed by fixing means to a device for dispensing freeze-dried drink 20 in which the cartridge 7 or supply receptacle 7 of particulate material is placed. In this figure, the left half of the first element 1 has intentionally been removed in order to better illustrate the functioning of the interior.

In this embodiment, the cartridge 7 rests on the second base plate 11.

The pedestal 6 of the cartridge 7 comprises an opening drawer 8. The opening drawer 8 can be in the open position or in the closed position. When the drawer is in the open position, it allows the release of a certain quantity of particulate material. This is the position depicted in this figure.

The drawer 8 is preferably composed of a frame with four faces (two lateral and two frontal), two of which (the two lateral faces) are arranged so as to be substantially parallel to the flanges 16 and set back with respect to the flanges 16.

The particulate material can be freeze-dried coffee, tea, soup or any other drink that can be found in freeze-dried form to which water must also be added but it may also be a soap in power form, a dentifrice, spices, sugar, flower or any other material in powder or granule form which could be useful in such a dispenser.

As mentioned previously (FIG. 1), in front of the first base plate 10 there is a first fixing means 5. The drawer, for its part, comprises a second fixing means 9 which is reciprocal with the first fixing means 5. By virtue of these aforementioned reciprocal fixing means 5, 9, the drawer is secured to the first element both in the closed position and in the open position.

The above-mentioned fixing means are chosen from amongst the fixing means consisting of at least one orifice 22 and at least one protuberance designed to be housed in the orifice 22 or at least one recess 9 and at least one protuberance 5 designed to be housed in the recess 9 or the aforementioned two pairs of means of fixing together. The opposites are also possible in each case.

When the protuberance 5 is housed in the recess on the front face of the drawer, this is fixed to the first element 1 of the base unit 10 according to the invention. So that the receptacle delivers a quantity of particulate material, it suffices to exert a pressure on the front face 22, this pressure has the effect of making the supply receptacle/cartridge 7 retract, the device is in the product delivery position and a quantity of product falls for example into the receptacle provided for this purpose.

In the embodiment described in FIG. 5, the pressure by the user causes a slight rotation of the cartridge through the presence of the pivot means 14 and 15, the bottom of the cartridge retracts, the front face of the drawer being fixed, the device is in the product delivery position and a quantity of product falls for example into the receptacle provided for this purpose.

It can also be envisaged that the first internal element does not have a front face, in this case the user directly exerts a pressure on the cartridge, and the effect obtained described just above is the same.

If the most simple embodiment is taken (FIG. 1), the supply receptacle is placed in the first element 1, in this case the cartridge rests directly on the first base plate 2. The user exerts a pressure directly on the cartridge, the latter retracts with a rearward translation movement, as the front face of the supply drawer is secured to the first element, the device is in the product delivery position and the quantity of product falls for example into the receptacle provided for this purpose. It can also be envisaged that the first base plate comprises flutes or grooves for guiding either the flanges of the cartridge base or directly the cartridge base, the presence of the flanges being preferential for reasons of lessening of the friction resistance.

In the embodiment described in FIG. 5, it is possible to limit the rotation of the second element 10 in the first element 1 by inserting a chock in one of the orifices 19 in the two rows of openings 18. The row of openings in FIG. 4 is situated on the second rear wall 12. This has the effect of limiting the angle of rotation possible and consequently the relative opening between the cartridge 7 and the drawer 8 is also limited. This obviously limits the quantity of particulate material delivered. In this embodiment, the row of openings 18 is particularly accessible to the user, who can better apportion the quantity of particulate material that it requires, and inserting the chock is easy.

The rows of openings 18 could also be situated on the first rear wall 3. It would keep its role of rotation angle limiter, but its accessibility would be reduced.

The chock in question can be in the shape of a crescent moon, an I, an L or a U, or any other shape where at least one end can be inserted easily into one of the orifices 19.

In a variant of the most simple embodiments (not illustrated), the second element 10 is housed in the first element 1, the cartridge 7 rests on the second base plate 11, but the pivot means 14, 15 are replaced by translation means. In this case, it can be envisaged that the first base plate 2 would comprise flutes or grooves or a wide groove for guiding the second base plate 11. In this case, when the user wishes to make use of the device according to the invention, he exerts a pressure either on a front wall of the second element or directly on the cartridge, if there is no front face on the second element. In this case, the front face of the drawer is fixed and secured to the external element, the pressure exerted by the user will result in a rearward translation movement of the second element containing the cartridge, the device is in the product delivery position and a quantity of product falls for example into the receptacle provided for this purpose.

Advantageously, in the variant described just above, the second top part 3b is a part inclined by an angle of between 91° and 135° in a trigonometric reference frame. The first base plate 2 being positioned in the said trigonometric reference frame with an angle substantially zero or equalling 180°, that is to say substantially horizontal. The fourth top part 12b is then also inclined by an angle substantially equal to the angle of inclination of the second top part 3b. This inclination facilitates the insertion of the cartridge.

In addition, there can also be provided, on the rear face of the second element, part of which is inclined, the presence of a guidance means 17 which guides any flanges 16 on the base 6 of the cartridge 7. This facilitates even more the introduction of the cartridge 7 into the base unit 21 according to the invention. This is because the user only has to place the cartridge 7 provided with its base 6 close to the top of the rail in relief 17. He then adjusts the flanges 16 on each side of the rail 17 in relief in question and the cartridge 7 of particulate material is guided downwards by virtue of the particular shape of the rail 17 and the rear walls 3, 12, gravity and the action of the user. It suffices to support the cartridge 7 and during its descent to raise it slightly vertically at the join between the third bottom part 12a and the fourth top part 12b.

In the most simple embodiment (FIG. 1), it is possible to limit the translation of the cartridge 7 in the first element 1 by inserting a chock in one of the orifices 19 in the rows of openings 18 provided on the base plate 2 of the first element. This has the effect of limiting the possible rearward translation distance of the pedestal 6 of the cartridge 7. Consequently the relative opening between the cartridge 7 and the drawer 8 is also limited, just like the quantity of particulate material delivered.

In the variant of the most simple embodiment, it is also possible to limit the translation of the second element 10 in the first element 1 by inserting a chock in one of the orifices 19 in the rows of openings 18 which are provided on the base plate 2. This has the effect of limiting the possible rearward translation distance of the second element 10. Consequently the relative opening between the cartridge 7 and the drawer 8 is also limited, just like the quantity of particulate material delivered.

Naturally the present invention is in no way limited to the embodiments described above and many modifications can be made thereto without departing from the scope of the accompanying claims.

For example, in the most simple embodiment illustrated in FIG. 1, the first rear wall 3 could also have the guide rail 17 for facilitating the insertion of the cartridge 7.

### LIST OF ELEMENTS

1. First element
2. First base plate of first element
3. First rear wall of first element
   3a. First bottom part of first rear wall
   3b. Third top part of first rear wall
4. Lateral walls of first element
5. First fixing means
6. Pedestal of supply receptacle (cartridge)
7. Supply receptacle (cartridge)
8. Opening drawer
9. Second fixing means
10. Second element
11. Second base plate of second element
12. Second rear wall of second element
   12a. Second bottom part of second rear wall
   12b. Fourth top part of second rear wall
13. Lateral walls of second element
14. Pivot means of first element
15. Pivot means of second element
16. Pedestal flanges
17. Means of guiding the second rear wall
18. Rows of openings
19. Orifice
20. Particulate material dispensing device
21. Base unit
22. Fixing orifice
23. Front face

1. Base unit for a device for dispensing particulate material, in particular freeze-dried drinks, comprising:
a first element (1) that comprises a first base plate (2), said first base plate being substantially horizontal, said first element (1) further comprises first and second lateral walls (4), substantially perpendicular to the first base plate (2), and
a first fixing means (5),
the first element (1) is designed to receive a pedestal (6) on the first base plate (2), the pedestal (6) being designed to house a receptacle (7) for supplying the particulate material and being provided with an opening drawer (8), the opening drawer (8) comprising an open position and a closed position and in addition a second fixing means (9) reciprocal with the first fixing means (5), the drawer (8) being designed for the release of a quantity of the particulate material coming from the receptacle (7) when it is in the open position,
wherein the first fixing means (5) is situated in front of the first base plate (2).

2. Base unit as claimed in claim 1, wherein a second element (10) is further comprised, the second element (10) being designed to be housed in the first element (1) and to house therein the receptacle (7) for supplying the particulate material with its base (6), the second element (10) comprising at least:
a second substantially horizontal base plate (11)
a second rear wall (12),
third and fourth lateral walls (13), substantially perpendicular to the second base plate (11),
the first element (1) and the second element (10) being designed to be able to move with respect to each other.

3. Base unit as claimed in claim 2, wherein the first element (1) comprises at least a first translation means and the second element (10) comprises at least a second translation means, reciprocal with the above mentioned first translation means.

4. Base unit as claimed in claim 2, wherein the first element (1) comprises at least a first pivot means (14) and the second element (10) comprises at least a second pivot means (15), reciprocal with the above-mentioned first pivot means.

5. Base unit as claimed in claim 2, wherein the rear wall (12) comprises guidance means (17) arranged so as to guide flanges (16) provided on lateral edges of the pedestal (6) of the receptacle (7).

6. Base unit as claimed in claim 2, wherein the first element (1) comprises a first rear wall (3) which comprises a first bottom part (3a) and a second top part (3b) which is curved and wherein the second rear wall (12) comprises a third bottom part (12a) and a fourth top part (12b) which is curved, the fourth top part (12b) having a curvature similar to that of the second curved part (3b) of the first element (1).

7. Base unit as claimed in claim 2, wherein the second rear part (12) of the second element (10) comprises at least a row (18) of openings (19), each opening (19) being designed to receive a chock.

8. Base unit as claimed in claim 7, in which the chock is in the shape of an L, a U, an I, a crescent moon and the like, preferably in the shape of an L.

9. Base unit as claimed in claim 1, wherein means of fixing to a support are provided.

10. Device (20) for dispensing particulate material, in particular freeze-dried drinks comprising the base unit (21) as claimed in claim 1.
